(19) United States
(12) Patent Application Publication
(10) Pub. No.: US 2016/0084808 A1
(43) Pub. Date: Mar. 24, 2016

(54) METHOD AND DEVICE FOR DETERMINING A COMPOSITION OF A GAS SAMPLE PROCESSED BY MEANS OF GAS CHROMATOGRAPHY

(71) Applicant: Commissariat a L'Energie Atomique et aux Energies Alternatives, Paris (FR)

(72) Inventors: Francois BERTHOLON, La Tronche (FR); Pierre GRANGEAT, Saint-lsmier (FR); Laurent GERFAULT, Tullins (FR); Olivier HARANT, Saint-Egreve (FR); Christian JUTTEN, La Ferriere (FR)

(73) Assignee: Commissariat a L'Energie Atomique et aux Energies Alternatives, Paris (FR)

(21) Appl. No.: 14/858,032

(22) Filed: Sep. 18, 2015

(30) Foreign Application Priority Data
Sep. 20, 2014 (FR) 14 58893

(51) Int. Cl. G01N 30/86; G01N 30/64

(52) U.S. Cl. CPC G01N 30/8693; G01N 30/64

(57) ABSTRACT

A method for determining a composition of a gas sample comprising the following steps: running the sample through a processing chain comprising a gas chromatography column and a gas detector arranged at the outlet of the gas chromatography column; obtaining, at the output of the detector, a representative electrical signal of the composition; determining the gas composition by processing this electrical signal. The determination of the composition of the sample is performed on the basis of a combination of a direct probabilistic model of the chromatography column, this model comprising at least one law of probability defining, for at least one gas species liable to be found in the sample, a probability at each moment that a molecule of this gas species is discharged from the chromatography column, and an impulse response model of the detector. It is performed by inverting this combination of models using the electrical signal.

The present invention relates to a method for determining a composition of a gas sample processed by means of gas chromatography. It also relates to a device using this method.

### BACKGROUND OF THE INVENTION

The invention applies more particularly to a method comprising the following steps:
running the sample through a processing chain comprising a gas chromatography column and a gas detector arranged at the outlet of the gas chromatography column,
obtaining, at the output of the gas detector, a representative electrical signal of the composition of the sample,
determining the composition of the sample using a device for processing this electrical signal.

### DESCRIPTION OF THE PRIOR ART

Such a method is used in devices available from APIX Technology company, as for example described in the patent application FR 2 996 219 A1. According to this method, at the outlet of the chromatography column, a portion of the molecules of different gas species of the sample is adsorbed onto a vibrating beam sensor of an electromechanical gas detector thus inducing one or a plurality of temporary drops in the fundamental and harmonic resonance frequencies of this vibrating beam. Studying one of the resonance modes of the electromechanical gas detector then makes it possible to detect this or these temporary frequency drop(s) in order to identify or quantify the gas species present in the sample individually.

Thanks to the rapid development of technologies in terms of miniaturization, it is now possible to develop gas chromatography columns on a micrometric scale and gas detectors on a nanometric scale, the latter being advantageously designed based on NEMS (“Nano Electro Mechanical Systems”) sensors, in order to analyze ever smaller sample volumes and avail of adaptable and transportable measurement tools in numerous environments.

Particularly promising applications currently under study relate for example non-exhaustively to:
the detection of hazardous gas species in the air, in the fields of nuclear, radiological, biological and chemical risk prevention,
the detection of explosives in the field of counter-terrorism,
the detection of toxic pollutants in the water such as polycyclic aromatic hydrocarbons, such detection generally involving a liquid-phase pre-analytical step and a gas-phase analytical step,
the determination of the heating value of a natural gas by determining the specific composition thereof in identified gas species, this heating value indeed being suitable for being estimated very simply as a linear combination of the known heating values of the identified gas species weighted by the respective concentrations thereof in a natural gas sample.

The latter application has non-negligible stakes for industrial firms in the field of energy. Indeed, the selling price of natural gas is based on the heating value thereof, expressed in KWh. It is thus particularly advantageous to be able to avail of measurement tools suitable for being fitted on gas transport pipelines or for individuals in order to monitor in real time the heating value of a natural gas transported or supplied.

However, the signal processing proposed, particularly in the document FR 2 996 219 A1, generally remains relatively basic and lacks precision whereas the frequency drop times, the extent of these frequency drops or the form adopted by these frequency variations in the signal provided by the gas detector represent relevant information in the analysis of the composition of the gas sample.

It may thus be sought to provide a method for determining a composition of a gas sample treated by means of gas chromatography suitable for enhancing the analysis of the signal obtained at the outlet of the gas detector.

### SUMMARY OF THE INVENTION

A method such as that defined above is thus proposed wherein the composition of the sample is determined on the basis of a combination stored in memory:
of a direct probabilistic model of the gas chromatography column, this model comprising at least one law of probability defining, for at least one gas species liable to be found in the sample, a probability at each moment that a molecule of this gas species is discharged from the chromatography column, and
an impulse response model of the gas detector,
   and wherein the determination step is performed by inverting this combination of models using the electrical signal, the inversion being performed by the processing device having means for accessing the memory.

As such, by modeling the processing chain in a probabilistic manner, the direct analysis of the signal obtained at the output of this chain can be refined such that applying an inversion subsequently makes it possible to accurately determine the, in principle, unknown composition of a sample passing through this processing chain. It should further be noted that the parameters of the models involved in this method may be defined simply, for example either by means of a specific learning process, or by means of a realistic model based on experience, such that the implementation of the method proves to be simple. The direct probabilistic model of the gas chromatography column may particularly be determined on the basis of at least one technical parameter of this column.

Optionally, the direct probabilistic model of the gas chromatography column comprises a law of probability defined for each gas species of a reference set of predetermined gas species, this law of probability defining a probability at each moment that a molecule of the gas species in question is discharged from the chromatography column. The parameters of this law may particularly be expressed on the basis of the following technical parameters of the chromatography column:
an adsorption factor of the gas species in question in the chromatography column,
a desorption factor of the gas species in question in the chromatography column,
a down-time corresponding to the time taken by a carrier gas without affinity with the wall thereof to pass through this chromatography column.

The parameters of this law may also be determined experimentally, for each of said predetermined gas species.

Also optionally, the law of probability defined for each gas species in the direct probabilistic model of the gas chromatography column takes the following form:

$${P}_{j} ( t , {θ}_{j} ) = \frac{\sqrt{4 \cdot {k}_{a , j} \cdot {k}_{d , j} \cdot {t}_{0} \cdot t}}{2 \cdot t} \cdot {I}_{1} \cdot ( \sqrt{4 \cdot {k}_{a , j} \cdot {k}_{d , j} \cdot {t}_{0} \cdot t} ) \cdot {e}^{- {k}_{a , j} \cdot {t}_{0} - {k}_{d , j} \cdot t} ,$$

where t is the time, t≧0, the index j identifies the gas species in question, k_{a,j} is the adsorption factor of this gas species in the chromatography column, k_{d,j} is the desorption factor of this gas species in the chromatography column, θⱼ=(k_{a,j}, k_{d,j}), I₁ is the first-order modified Bessel function of the first kind and t₀ is the down-time of the chromatography column.

Also optionally, the impulse response model of the gas detector comprises a law of probability defined for each gas species of a reference set of predetermined gas species, this law of probability defining a probabilistic impulse response of the electromechanical gas detector to an impulse constituted by a molecule of the gas species in question. This probabilistic impulse response of the gas detector may be obtained analytically, by defining a direct model, but it may also be obtained experimentally.

Also optionally, the gas detector is an electromechanical gas detector and the parameters of each law of probability of said impulse response model are expressed on the basis of technical parameters of the gas detector including:
an adsorption factor of the gas species in question in the electromechanical gas detector,
a desorption factor of the gas species in question in the electromechanical gas detector,
an interaction time corresponding to the presence time of a molecule in the mobile phase with regard to the electromechanical gas detector.

Also optionally, the law of probability defined for each gas species in the impulse response model of the electromechanical gas detector takes the following form:

rⱼ(t)=mmⱼ·(1−e^{-k}^{_{a,j}}^{^{NEMS}}^{·T}^{ₑ})·f_{heaviside}(t)·e^{-k}^{_{d,j}}^{^{NEMS}}^{·t},

where t is the time, the index j identifies the gas species in question, mmⱼ is the molecular mass of this gas species, k_{a,j}^{NEMS} is the adsorption factor of this gas species in the electromechanical gas detector, k_{d,j}^{NEMS} is the desorption factor of this gas species in the electromechanical gas detector, f_{heaviside} is the Heaviside function and Tₑ is the integration time of the electromechanical gas detector.

Also optionally, the combination of the models stored in memory is a linear combination of convolution products between the laws of probability of the direct probabilistic model of the gas chromatography column and the laws of probability of the impulse response model of the electromechanical gas detector, this linear combination taking the following form:

$${g}_{k} ( t ) = {g}_{0 , k} - {α}_{k} {\sum }_{j = 1}^{N} {C}_{j} \cdot {P}_{j} ( t , {θ}_{j} ) * {r}_{j} ( t ) + ɛ ( t ) ,$$

where t is the time, the index k identifies a fundamental or harmonic resonance frequency mode of the electromechanical gas detector, gₖ(t) is an instantaneous mode k resonance frequency of the electromechanical gas detector, this instantaneous frequency forming the electrical signal obtained at the output thereof, g_{0,k} is an off-load instantaneous mode k resonance frequency of the electromechanical gas detector, αₖ is a mode k weighting constant, N is the number of gas species in the sample, the index j identifies a gas species, Cⱼ is the molecular concentration of this gas species in the sample, Pⱼ(t, θⱼ) is the law of probability of the direct probabilistic model of the gas chromatography column for this gas species, rⱼ(t) is the law of probability of the impulse response model of the gas detector for this gas species and ε(t) is a probabilistic noise model.

Also optionally, the inversion of said combination of models includes the following steps:
compiling a basis of N representative vectors of N known gas species of the sample, each vector of this basis being defined in the form Pⱼ(t, θⱼ)*rⱼ(t) where Pⱼ(t, θⱼ) is the law of probability of the direct probabilistic model of the gas chromatography column for the j-th gas species and rⱼ(t) is the impulse response model of the gas detector for the j-th gas species,
inverting said combination of models on the basis of the electrical signal so as to obtain a proportion value for each gas species of the sample.

Also optionally, the inversion of said combination of models includes the following steps:
compiling a basis of N representative vectors of N known gas species of the sample, each vector of this basis being defined in the form Pⱼ(t, θⱼ)*rⱼ(t) where Pⱼ(t, θⱼ) is the law of probability of the direct probabilistic model of the gas chromatography column for the j-th gas species and rⱼ(t) is the impulse response model of the gas detector for the j-th gas species,
compiling a dictionary of N′ representative vector kernels, where N′≧N, each gas species being associated with one or a plurality of vector kernels, each vector kernel being obtained:
   either on the basis of the vectors (Pⱼ(t, θⱼ)*rⱼ(t))_{1≦j≦N} by modulating the value of some technical parameters, for example chosen from k_{a,j}, k_{d,j}, k_{a,j}^{NEMS}, k_{d,j}^{NEMS}, t₀, Tₑ,
   or on the basis of an arbitrary noise model, notably describing a baseline of the electrical signal,
inverting said combination of models (Pⱼ, rⱼ) on the basis of the electrical signal (gₖ(t)) so as to obtain a proportion value for each gas species of the sample.

Also optionally, the inversion of said combination of models includes the following steps:
compiling a basis of P representative vectors of P known or predetermined gaseous substances of the sample, each vector of this basis being defined in the form Eᵢ(t)=Σⱼ₌₁^{N} p_{i,j}·Pⱼ(t, θⱼ)*rⱼ(t) where Pⱼ(t, θⱼ) is the law of probability of the direct probabilistic model of the gas chromatography column for the j-th gas species, rⱼ(t) is the impulse response model of the gas detector for the j-th gas species and p_{i,j} expresses the probability that a molecule of the i-th gaseous substance is of the j-th gas species,
inverting said combination of models (Pⱼ, rⱼ) on the basis of the electrical signal (gₖ(t)) so as to obtain a proportion value for each gaseous substance of the sample.

Also optionally, the inversion of said combination of models includes the following steps:
compiling a basis of P representative vectors of P known or predetermined gaseous substances of the sample, each vector of this base being defined in the form Eᵢ(t)=Σⱼ₌₁^{N} p_{i,j}·Pⱼ(t, θⱼ)*rⱼ(t) where Pⱼ(t, θⱼ) is the law of probability of the direct probabilistic model of the gas chromatography column for the j-th gas species, rⱼ(t) is the impulse response model of the gas detector for the j-th gas species and p_{i,j} expresses the probability that a molecule of the i-th gaseous substance is of the j-th gas species,
compiling a dictionary of P′ representative vector kernels, where P′≧P, each gaseous substance being associated with one or a plurality of vector kernels, each vector kernel being obtained:
   either on the basis of the vectors (Eᵢ(t))_{1≦i≦P} by modulating the value of some technical parameters, for example chosen from k_{a,j}, k_{d,j}, k_{a,j}^{NEMS}, k_{d,j}^{NEMS}, t₀, Tₑ,
   or on the basis of an arbitrary noise model, notably describing a baseline of the electrical signal,
inverting said combination of models (Pⱼ, rⱼ) on the basis of the electrical signal (gₖ(t)) so as to obtain a proportion value for each gaseous substance of the sample.

Also optionally, the determination step by means of inversion uses a Bayesian estimator.

Also optionally, the electrical signal obtained at the output of the gas detector is previously denoised before performing the determination step, this denoising including the removal of a baseline and being carried out by breaking the electrical signal down into wavelets and selecting merely a portion of the wavelet components obtained.

A device for determining a composition of a gas sample processed by means of gas chromatography is also proposed, comprising:
a sample processing chain comprising a gas chromatography column and a gas detector arranged at the outlet of the gas chromatography column, designed to supply a representative signal of the composition of the sample, and
a signal processing device designed materially or programmed to apply, in conjunction with the processing chain, a method for determining the composition of the gas sample according to the invention.

Optionally, the gas detector is a NEMS electromechanical detector.

### BRIEF DESCRIPTION OF THE DRAWINGS

The invention will be understood more clearly using the description hereinafter, given merely by way of example with reference to the appended figures wherein:

FIG. 1 schematically represents the general structure of a device for determining a composition in terms of gas species of a sample processed by means of gas chromatography according to one embodiment of the invention,

FIG. 2 illustrates a direct probabilistic model of a processing chain of the device in FIG. 1, according to one embodiment of the invention,

FIG. 3 is a timing diagram illustrating an example of an output signal of a gas detector of the device in FIG. 1, and

FIG. 4 illustrates the successive steps of a method for determining a composition in terms of gas species of a sample processed by means of gas chromatography used by the device in FIG. 1.

### DESCRIPTION OF THE PREFERRED EMBODIMENTS

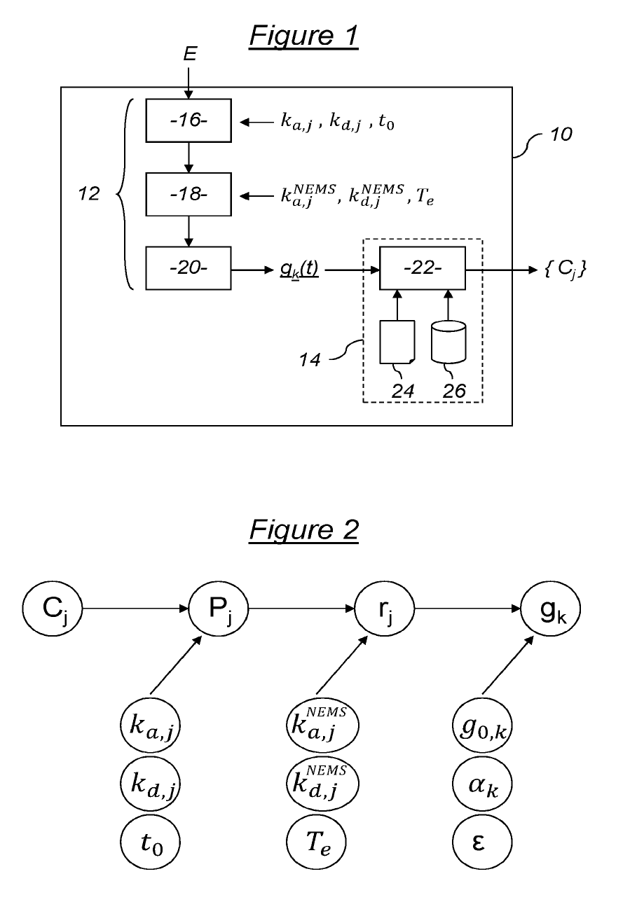

The device 10 for determining a composition in terms of gas species of a sample E processed by means of gas chromatography, schematically represented in FIG. 1, comprises a chain 12 for processing the sample E designed to supply a representative signal gₖ(t) of this composition on the basis of technical parameters of the processing chain 12. It further comprises a signal processing device 14 designed to apply, in conjunction with the processing chain 12, a method for estimating this composition on the basis of the technical parameters of the processing chain 12.

In the example to be detailed hereinafter but which should not be considered to be limiting, the composition to be estimated is a set of proportion values {C₁, . . . , Cⱼ, . . . , C_{N}} of N gas species {G₁, . . . , Gⱼ, . . . , G_{N}} in the sample E. In a further simplified example, the estimated composition could be merely qualitative, without being quantitative. It would then consist merely of identifying one or a plurality of gas species present in the sample E, without needing to estimate the respective proportions or concentrations thereof specifically.

In the processing chain 12, the sample E is first injected in gas phase into a gas chromatography column 16 wherein a carrier gas is circulating.

The chromatography column 16 comprises an adsorbent wall with which the carrier gas has no affinity, i.e. the molecules thereof are not adsorbed. On the other hand, the molecules of the various gas species of the injected sample may be more or less adsorbed by this wall according to the nature thereof. This results in a variable degree of slowing down of the progression of some gas species in the column. The travel time of the sample E, and more specifically of the various constituent gas species thereof, is referred to as the retention time and is characteristic of the nature of the gas.

The carrier gas having no affinity with the wall of the chromatography column 16, it is not slowed down in the progression thereof. The movement speed thereof is assumed to be constant. The travel time thereof, minimal in the chromatography column, is referred to as “down-time” and represents a first technical parameter t₀ of the chromatography column 16.

Unlike the carrier gas, each gas species of the sample has a certain affinity with the wall of the chromatography column 16. This affinity may be defined using two specific technical parameters for each gas species Gⱼ, the first parameter being the adsorption factor k_{a,j} and the second, the desorption factor k_{d,j}. The adsorption factor k_{a,j} represents the probability per unit of time that a molecule of the gas species Gⱼ, in the mobile phase in the chromatography column 16, enters the stationary phase by adsorption. The reciprocal thereof thus represents the mean time that a molecule of the gas species in question remains in the mobile phase. The desorption factor k_{d,j} represents the probability per unit of time that a molecule of the gas species Gⱼ, in the stationary phase in the chromatography column 16, is desorbed. The reciprocal thereof thus represents the mean time that a molecule of the gas species in question remains in the stationary phase. Hence, the sum (k_{a,j})⁻¹+(k_{d,j})⁻¹ represents the retention time of the gas species Gⱼ, in the chromatography column 16.

It is thus possible to establish a direct probabilistic model of the gas chromatography column on the basis of at least one of the technical parameters thereof, particularly on the basis of the parameters t₀, k_{a,j} and k_{d,j}. This probabilistic model may be broken down into a law of probability for each gas species, defining a probability at each time t annotated Pⱼ(t, θⱼ), where θⱼ=(k_{a,j}, k_{d,j}), that a molecule of the gas species Gⱼ is discharged from the chromatography column 16. A non-limiting example of such a direct probabilistic model is given in the article by Felinger, entitled “Molecular dynamic theories in chromatography”, Journal of Chromatography A, vol. 1184, pages 20-41, January 2008. Each law of probability defined for each gas species Gⱼ in this probabilistic model takes the following form:

$${P}_{j} ( t , {θ}_{j} ) = \frac{\sqrt{4 \cdot {k}_{a , j} \cdot {k}_{d , j} \cdot {t}_{0} \cdot t}}{2 \cdot t} \cdot {I}_{1} \cdot ( \sqrt{4 \cdot {k}_{a , j} \cdot {k}_{d , j} \cdot {t}_{0} \cdot t} ) \cdot {e}^{- {k}_{a , j} \cdot {t}_{0} - {k}_{d , j} \cdot t} ,$$

for any t≧0, where I₁ is the first-order modified Bessel function of the first kind. Obviously, for any t≦0, Pⱼ(t, θⱼ)=0.

As such, the direct probabilistic model of the gas chromatography column may be established on the basis of at least one technical parameter of the column. Alternatively, this direct probabilistic model may be determined experimentally, for each gas species in question.

At the outlet of the chromatography column 16, the gas species molecules of the sample E encounter a gas detector 18 of the processing chain 12. In the example represented by the embodiment in question, the gas detector 18 is electromechanical. Advantageously, for the purposes of compact design and transportability, it consists of a NEMS detector. However, it could consist more generally of any gas detector wherein the impulse response is suitable for probabilistic modeling, such as for example a TCD (“Thermo Conductive Device”) detector wherein the impulse response may comprise a gain component and an impulse response component of the acquisition electronics, or an FID (“Flame Ionization Detector”) detector wherein the impulse response may also comprise a gain component and an impulse response component of the acquisition electronics.

As a general rule, the impulse response of the gas detector 18 may be determined according to modeling of the response of the detector for each gas species in question, this modeling being notably carried out on the basis of technical parameters of the detector. It may also be obtained experimentally, for each gas species in question.

The NEMS detector 18 is a gravimetric sensor consisting of a functionalized nanometric beam and a system activating the vibration thereof at a certain resonance frequency by means of actuators. Gauges measure the amplitude of the movements of the beam by the piezoelectric effect. Such a NEMS detector is based on the following physical property: when a molecule is adsorbed by the nanometric beam, the resonance frequency thereof falls proportionally to the mass added by the molecule. Indeed, the beam can be considered to be subject to a linear force wherein the effect is only spatially dependent on the position along the beam. If this force is oscillatory and the resulting differential equation is written in the Laplace domain, the beam appears to act as a damped resonant system having the resonance frequency

$$g = \sqrt{\frac{K}{M}} ,$$

where K is the stiffness constant of the beam and M the effective mass of the beam in vibration.

Consequently, by adding by adsorption a molecule having the mass dm to the beam, the following resonance frequency is obtained:

$${ℊ}^{′} = \sqrt{\frac{K}{M + d m}} = \sqrt{\frac{K}{M ( 1 + \frac{d m}{M} )}} ,$$

or, by making a first-order limited development (dm<<M):

$${ℊ}^{′} - ℊ = - \frac{ℊ}{2 M} d m .$$

The frequency drop is thus indeed proportional to the adsorbed mass and it is possible, by generalizing to any of the fundamental or harmonic resonance modes, express the instantaneous mode k resonance frequency of the electromechanical gas detector 18 in the following form:

gₖ(t)=g_{0,k}−α′ₖ·m(t)+ε(t),

where g_{0,k} is the off-load instantaneous mode k resonance frequency of the electromechanical gas detector, α′ₖ is a mode k weighting constant, m(t) is the mass absorbed at the time t and ε(t) is a probabilistic noise model.

This instantaneous frequency may be measured by keeping the electromechanical gas detector 18 in resonance using a closed-loop self-oscillation circuit. However, this results in an interaction time corresponding to the presence time of a molecule in the mobile phase with regard to the detector. In other words, this time determines a duration during which a gas molecule is liable to be adsorbed by the functionalized beam of the detector. This interaction time represents a first technical parameter Tₑ of the electromechanical gas detector 18.

Moreover, the electromechanical gas detector 18 has similar adsorption and desorption properties to those of the chromatography column 16, each gas species of the sample E having a certain affinity with the functionalized nanometric beam, although the functionalization of the beam is not necessarily the same as that of the chromatography column. This affinity can be defined using two specific technical parameters to each gas species Gⱼ, the first parameter being the adsorption factor k_{a,j}^{NEMS} and the second, the desorption factor k_{d,j}^{NEMS}. These two technical parameters of the electromechanical gas detector 18 have the same significance as that of the chromatography column 16. The values of these two parameters are dependent on the nature of the coating, which functionalizes the beam of the electromechanical gas detector 18, with which the gas molecules are liable to be adsorbed and desorbed. They may notably adopt different values if the coating layer functionalizing the electromechanical gas detector 18 is different from the coating layer functionalizing the chromatography column 16.

A probabilistic analysis suitable for expressing the mass m(t) adsorbed at each time t by the electromechanical gas detector 18 on the basis of at least one of the technical parameters thereof, notably on the basis of the parameters Tₑ, k_{a,j}^{NEMS} and k_{d,j}^{NEMS} may be performed. According to this analysis, on the assumption that molecule adsorption takes place instantaneously at the outlet of the chromatography column 16, the probability that a molecule of the gas species Gⱼ is adsorbed by the electromechanical gas detector 18 at the time t is expressed as follows:

pⱼ^{NEMS}(t,θⱼ)=pⱼ·Pⱼ(t,θⱼ),

where pⱼ is the probability that a molecule of the gas species Gⱼ is adsorbed by the electromechanical gas detector 18 given that it is discharged from the chromatography column 16, independently of this discharge time.

In view of the teaching of the article by Felinger cited above and in that the adsorption in the electromechanical gas detector 18 is performed in the same way as in the chromatography column 16, the probability pⱼ may be expressed as follows:

$${p}_{j} = {\int }_{τ = 0}^{{T}_{e}} {f}_{m , j} ( τ ) d τ = 1 - {e}^{{k}_{a , j}^{NEMS} \cdot {T}_{e}} ,$$

where f_{m,j} is the probability density, for a molecule of the gas species Gⱼ in the mobile phase, relative to the waiting time r before adsorption. This time τ observes an exponential law due to the Poisson adsorption-desorption process, such that:

f_{m,j}(τ)=k_{a,j}^{NEMS}·e^{-k}^{_{a,j}}^{^{NEMS}}^{·τ}.

Moreover, the probability that a molecule of the gas species Gⱼ, which was adsorbed at a time u, remains adsorbed by the electromechanical gas detector 18 at least up to a time t is expressed as follows:

$${\int }_{τ = t - u}^{∞} {f}_{s , j} ( τ ) d τ = {\int }_{τ = t - u}^{∞} {k}_{d , j}^{NEMS} \cdot {e}^{- {k}_{d , j}^{NEMS} \cdot τ} d τ = {e}^{- {k}_{d , j}^{NEMS} \cdot ( t - u )} ,$$

where f_{s,j} is the probability density, for a molecule of the gas species Gⱼ in the stationary phase, relative to the waiting time τ before desorption which also observes an exponential law due to the Poisson adsorption-desorption process.

From the above, we infer the proportion of molecules Gj adsorbed at the time t:

$${n}_{j} ( t ) = {\int }_{u = 0}^{t} [ {P}_{j}^{NEMS} ( u , {θ}_{j} ) ] \cdot [ {\int }_{τ = t - u}^{∞} {f}_{s , j} ( τ ) d τ ] d u ,$$

hence:

$${n}_{j} ( t ) = {\int }_{u = 0}^{t} {P}_{j}^{NEMS} ( u , {θ}_{j} ) \cdot {e}^{- {k}_{d , j}^{NEMS} \cdot ( t - u )} d u = {P}_{j}^{NEMS} ( t , {θ}_{j} ) * [ {f}_{heaviside} ( t ) \cdot {e}^{- {k}_{d , j}^{NEMS} t} ]$$

Given that the total mass present at the time t on the beam can be written as:

$$m ( t ) = {N}_{T} {\sum }_{j = 1}^{N} m {m}_{j} \cdot {C}_{j} \cdot {n}_{j} ( t ) ,$$

a complete expression is obtained for m(t):

$$m ( t ) = {N}_{T} {\sum }_{j = 1}^{N} m {m}_{j} \cdot {C}_{j} \cdot {P}_{j}^{NEMS} ( t , {θ}_{j} ) * [ {f}_{heaviside} ( t ) \cdot {e}^{- {k}_{d , j}^{NEMS} \cdot t} ] , \\ i . e . \text{:}$$

$$m ( t ) = {N}_{T} {\sum }_{j = 1}^{N} m {m}_{j} \cdot {C}_{j} \cdot ( 1 - {e}^{- {k}_{a , j}^{NEMS} \cdot {T}_{e}} ) \cdot {P}_{j} ( t , {θ}_{j} ) * [ {f}_{heaviside} ( t ) \cdot {e}^{- {k}_{d , j}^{NEMS} \cdot t} ] .$$

In this expression, the formula:

rⱼ(t)=mmⱼ·(1−e^{-k}^{_{a,j}}^{^{NEMS}}^{·T}^{ₑ})·f_{heaviside}(t)·e^{-k}^{_{d,j}}^{^{NEMS}}^{·t}

is assimilable to the mechanical impulse response of the electromechanical gas detector 18.

It is thus possible to establish a direct probabilistic model of the electromechanical gas detector 18, notably mechanical, on the basis of at least one of the technical parameters thereof, notably on the basis of the parameters Tₑ, k_{a,j}^{NEMS} and k_{d,j}^{NEMS}. This probabilistic model may be broken down into a law of probability rⱼ(t) for each gas species, defining the probabilistic impulse response of the electromechanical gas detector to an impulse constituted by a molecule of the gas species in question.

Alternatively, the impulse response of the electromechanical gas detector 18 could include an electronic impulse response component, independent of the gas species Gⱼ, which would take for example the form U(t)=e^{-t/τ}.

By annotating αₖ=α′ₖ·N_{T}, the instantaneous mode k resonance frequency of the electromechanical gas detector is expressed as:

$${ℊ}_{k} ( t ) = {ℊ}_{0 , k} - {α}_{k} {\sum }_{j = 1}^{N} {C}_{j} \cdot {P}_{j} ( t , {θ}_{j} ) * {r}_{j} ( t ) + ɛ ( t ) .$$

This instantaneous resonance frequency obtained at the output of the processing chain 12 is thus the result of a linear combination of convolution products between the laws of probability of the direct probabilistic model of the gas chromatography column 16 and the laws of probability of the direct probabilistic model of the electromechanical gas detector 18.

Finally, the processing chain 12 comprises a system 20 for the electronic reading of instantaneous resonance frequencies of the electromechanical gas detector 18 to supply the electrical signal gₖ(t) which is then representative of the composition in terms of gas species of the sample E.

It should be noted that, in order to determine the technical parameters cited above and other constants of the processing chain 12, said chain may be calibrated or studied statistically using known samples of each of the gas species Gⱼ.

The electrical signal gₖ(t) is supplied at the input of the processing device 14. More specifically, the processing device 14 comprises a processor 22 connected to storage means notably comprising at least one programmed sequence of instructions 24 and a modeling database 26.

The database 26 comprises technical and statistical parameters of the direct probabilistic modeling of the electrical signal gₖ(t) detailed above.

On the supply of the electrical signal actually observed gₖ(t), the programmed sequence of instructions 24 is designed to solve the inversion of this probabilistic model.

The sequence of instructions 24 and the database 26 are functionally presented as separate in FIG. 1, but in practice they may be distributed differently into data files, source codes or libraries without making any changes to the functions carried out.

As illustrated in FIG. 2, the input and output signals of the processing chain 12, the technical parameters and the probabilistic models defined above have a dependency relationship with each other, resulting in a hierarchical global probabilistic model.

As such, the set of the laws of probability Pⱼ relating to the chromatography column 16 is defined as dependent on the down-time t₀ and the adsorption/desorption parameters k_{a,j}, k_{d,j}. The application of this direct probabilistic model is further dependent on the proportions Cⱼ of the different gas species making up the sample E.

As such also, the set of the laws of probability rⱼ relating to the electromechanical detector 18 is defined as dependent on the integration time Tₑ and the adsorption/desorption parameters k_{a,j}^{NEMS}, k_{d,j}^{NEMS}. The application of this direct probabilistic model is further dependent on the output of the chromatography column 16.

Finally, the electrical signal gₖ(t) obtained at the output of the electromechanical gas detector 18 is defined as dependent on the constants g_{0,k} and αₖ and on the probabilistic noise model ε(t).

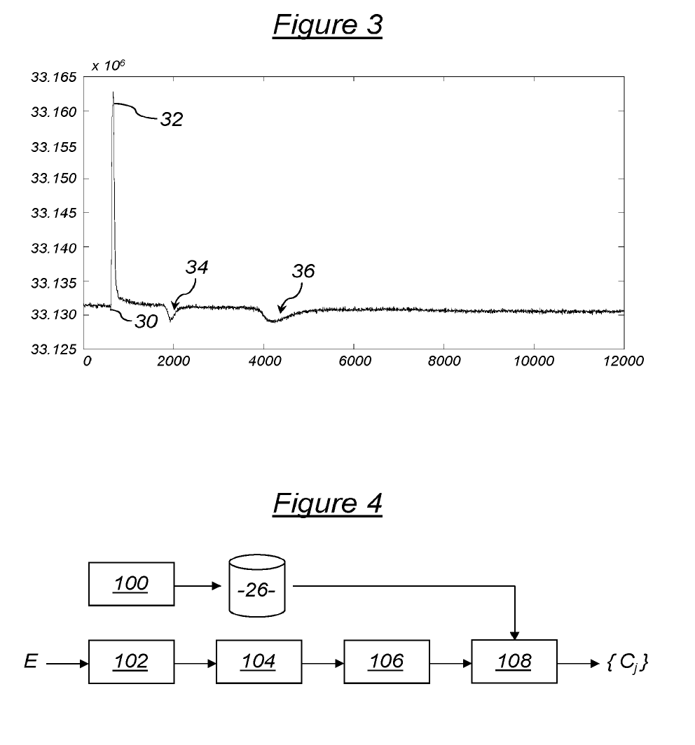

FIG. 3 illustrates an example of an electrical signal gₖ(t) obtained at the output of the processing chain 12. The amplitude thereof identified by the y-axis indicates the instantaneous resonance frequency of the electromechanical gas detector 18 and is expressed in MHz. This example is obtained with a sample E comprising a gaseous mixture of xylene, toluene and a carrier gas consisting of helium.

At a first time identified by the reference 30, the start of a first frequency peak indicates that the injection time of the sample E in the chromatography column 16.

At a second time identified by the reference 32, the vertex of this first frequency peak indicates, with reference to the first time, the arrival of the carrier gas at the end of the chromatography column 12, i.e. the down-time t₀.

At a third time identified by the reference 34, a first resonance frequency drop indicates the presence of toluene in the sample E. It is around this time that the toluene molecules are adsorbed and then rapidly desorbed in the electromechanical gas detector 18.

Finally, at a fourth time identified by the reference 36, a second resonance frequency drop indicates the presence of xylene in the sample E. It is around this time that the xylene molecules are adsorbed and then rapidly desorbed in the electromechanical gas detector 18.

It should further be noted that, according to the propagation rate applied to the molecules of sample E, there may be an imbalance between adsorption and desorption, both in the chromatography column 16 and in the electromechanical gas detector 18. This is the case when, during measurement, more molecules are adsorbed than desorbed. It also arises that the oscillating beam of the electromechanical gas detector 18 and the wall of the chromatographic column 16 contain molecules from a previous measurement which have not yet been desorbed. On the electrical signal gₖ(t), this results in the generation of a decreasing baseline, which is slightly visible in FIG. 3. The modeling of this baseline can be considered to be included in the noise model ε(t). Advantageously, it is possible to limit this baseline by performing a pre-acquisition with the sample E studied, in order to clear the processing chain 12 before the main acquisition. Advantageously also, it is possible to attempt to suppress or reduce this baseline with the noise by means of suitable processing of the electrical signal gₖ(t).

On the basis of the probabilistic model detailed above and illustrated in FIG. 2, a method for determining a composition in terms of gas species of a sample E processed by means of gas chromatography, used by the processor 22 by executing the sequence of instructions 24 will now be described.

According to a first application, for example for a precise determination of the composition of a gas mixture with a view to estimating the heating value thereof, it is assumed that the number N and the identity of the gas species in the sample E are known.

In this case, during a first calibration and initialization phase 100, the technical parameters k_{a,j}, k_{d,j}, t₀, k_{a,j}^{NEMS}, k_{d,j}^{NEMS} and Tₑ are determined, notably using reference samples for each of the known gas species of the gas mixture studied. They are also dependent on other quantities such as the inlet temperature or pressure of the chromatography column 16. During the same phase, a basis of N representative vectors of the N known gas species of the sample E is compiled. Each vector of this basis is defined in the form Pⱼ(t, θⱼ)*rⱼ(t). The technical parameters and the vectors cited above are saved in the database 26.

During a measurement step 102, according to the assembly in FIG. 1, the sample E passes through the entire processing chain 12 of the device 10.

During a subsequent reading step 104, the electrical signal gₖ(t) is supplied by the reading system 20.

Subsequently, during an optional filtering step 106, a first process intended to remove the noise ε(t), including the baseline mentioned above, is performed.

There are numerous known methods for carrying out such filtering. In particular, a method is taught in the PhD thesis by V. Mazet, entitled “Développement de méthodes de traitement de signaux spectroscopiques: estimation de la ligne de base et du spectre de raies” (Development of spectroscopic signal processing methods: baseline and line spectrum estimation), presented to Henry Poincaré University, Nancy (FR), in 2005.

An original method is further presented hereinafter. According to this method, the signal gₖ(t) is broken down in a manner known per se in a suitable wavelet basis. A suitable basis (eⱼ)_{1≦j≦N} means that the projection of the signal in this basis is suitable for clearly separating the wavelet components, between those representing the effective signal:

$${ℊ}_{k} ( t ) = {ℊ}_{0 , k} - {α}_{k} {\sum }_{j = 1}^{N} {C}_{j} \cdot {P}_{j} ( t , {θ}_{j} ) * {r}_{j} ( t ) ,$$

and those representing the noise ε(t) including the baseline.

In other words, a basis (eⱼ)_{1≦j≦N} is suitable if:

$${g}_{k} ( t ) = {\sum }_{j = 1}^{N} {a}_{j} {e}_{j} , where \vert {a}_{1} \vert > \vert {a}_{2} \vert > … > \vert {a}_{N} \vert ,$$

and if it is possible to filter the signal gₖ(t) by selecting merely n components, where n<N, representative of the effective signal.

It is within the scope of those skilled in the art to select a sufficiently parsimonious wavelet basis so that the effective signal is represented on a restricted number of wavelets and which is sufficiently selective so that the residue corresponding to the decomposition of the baseline and the noise on the selected wavelets can be ignored in view of the decomposition of the signal, and so that the decomposition of the signal on the non-selected wavelets is negligible in view of the decomposition of the signal on the selected wavelets.

Finally, during a final inversion step 108, the denoised electrical signal gₖ(t) is for example projected into the basis (Pⱼ(t, θⱼ)*rⱼ(t))_{1≦j≦N}, representing the inversion of the direct probabilistic model previously defined. Indeed, in view of the expression obtained for the signal gₖ(t) in the direct modeling thereof, such a projection is suitable for obtaining the proportion values {C₁, . . . , Cⱼ, . . . , C_{N}} of the N gas species {G₁, . . . , Gⱼ, . . . , G_{N}} identified in the sample E. This projection is carried out by minimizing the quadratic deviation between the denoised electrical signal gₖ(t) and the vector space generated by the basis (Pⱼ(t, θⱼ)*rⱼ(t))_{1≦j≦N}. Alternatively, the projection may be carried out on a basis obtained by means of orthonormalization of the basis (Pⱼ(t, θⱼ)*rⱼ (t))_{1≦j≦N}, for example based on a QR decomposition or by means of the Gram-Schmidt process. In this case, to obtain the proportion values {C₁, . . . , Cⱼ, . . . , C_{N}}, it is necessary to apply to the projection coefficients the transfer matrix of the basis (Pⱼ(t, θⱼ)*rⱼ(t))_{1≦j≦N} to the orthonormal basis obtained.

More generally, the determination of the quantities sought, in this instance that of the proportion values Cⱼ of each gas species in the mixture, is obtained by means of a method for inverting the electrical signal (gₖ(t)) in the basis consisting of the basis vectors (Pⱼ(t, θⱼ)*rⱼ(t))_{1≦j≦N}.

As such, according to one alternative embodiment, the inversion step 108 may be implemented using a Bayesian estimator, so as to estimate the parameters sought, in this instance the proportion values {C₁, . . . Cⱼ, . . . , C_{N}} of the N gas species {G₁, . . . Gⱼ, . . . , G_{N}} to be identified or previously identified in the sample E. It may consist for example of a retrospective expectation estimator if a noise-robust estimation method is sought. This estimator is in turn calculated using a Markov chain Monte Carlo method wherein the samples are obtained using a Gibbs loop. Teaching of such a procedure may for example be found in the European patent application published under the number EP 2 028 486 A1 or in that published under the number EP 2 509 018 A1. Further Bayesian estimators, such as a prospective maximum estimator, may be used.

Also alternatively, it may be sought to determine the composition of the gas mixture analyzed, not on the basis of the N known gas species, but on the basis of P gaseous substances, each of the gaseous substances consisting of at least a portion of the N gas species, given that this number P and the identity of the substances in the sample E are known and further given that the relative proportions of each gas species, in each of the P gaseous substances of the sample E, are known or predetermined.

In this case, the denoised electrical signal gₖ(t) should be projected, not into the basis (Pⱼ(t, θⱼ)*rⱼ(t))_{1≦j≦N}, but into a specific basis for the substances annotated (Eᵢ(t))_{1≦i≦P}. It is simple to express the vectors of this basis according to the vectors of the basis (Pⱼ(t, θⱼ)*rⱼ(t))_{1≦j≦N}. Indeed, the probabilities annotated p_{i,j}, each expressing the probability that a molecule of the i-th substance is of the gas species Gj, are generally known or predetermined, such that each vector of the basis (Eᵢ(t))_{1≦i≦P} can be expressed in the form of a law of probability:

$${E}_{i} ( t ) = {\sum }_{j = 1}^{N} {p}_{i , j} \cdot {P}_{j} ( t , {θ}_{j} ) * {r}_{j} ( t ) .$$

As above, the projection is for example carried out by minimizing the quadratic deviation between the denoised electrical signal gₖ(t) and the vector space generated by the basis (Eᵢ(t))_{1≦i≦P}. This gives proportion values, C′ᵢ, 1≦i≦P, of each gaseous substance in the mixture.

More generally, the determination of the quantities sought, in this instance that of the proportion values C′ᵢ of each gaseous substance in the mixture, is obtained by means of a method for inverting the electrical signal (gₖ(t)) in the basis consisting of the basis vectors (Eᵢ(t))_{1≦i≦P}. As such, as above and according to one alternative embodiment, the inversion step 108 may be implemented using a Bayesian estimator.

According to a further application, for example for detecting gas species in a gas mixture which is not known in principle, it is not possible to compile the basis (Pⱼ(t, θⱼ)*rⱼ (t))_{1≦j≦N} during the phase 100 as the gas species of the sample E are not identified.

In this case, the technical parameters k_{a,j}, k_{d,j}, t₀, k_{a,j}^{NEMS}, k_{d,j}^{NEMS} and Tₑ are still determined during the calibration and initialization phase 100. On the other hand, it is no longer a basis but a redundant dictionary of vector kernels or basis vectors denoted by the term “atoms”, ideally each acting as the identification of a gas species potentially present in the sample E, which is compiled. The dictionary advantageously comprises a number N′ of atoms, where N′ is greater than or equal to the number N of gas species present in the sample E. If the processing chain has been calibrated with N known gas species, the dictionary may be compiled on the basis of the set {Pⱼ(t, θᵢ)*rⱼ(t)}_{1≦j≦N} intended to be stored in the database 26, this set suitable for being completed by vector kernels obtained:
either on the basis of the vector kernels {Pⱼ(t, θⱼ)*rⱼ(t)}_{1≦j≦N} by modulating the value of some technical parameters, for example chosen from those of the chromatography column 16 or of the electromechanical gas detector 18,
or on the basis of an arbitrary noise model, notably describing the baseline of the electrical signal.

The sequence of steps 102 to 108 is then identical to that described in the case of the first application, with the exception of the inversion step 108 during which the projection is replaced by an expression of the electrical signal gₖ(t) using at least a portion of the atoms of the dictionary, each atom being associated with a basis vector suitable for being:
either obtained on the basis of the vectors {Pⱼ(t, θⱼ)*rⱼ(t)}_{1≦j≦N} by modulating the value of some technical parameters, for example chosen from those of the chromatography column 16 or of the electromechanical gas detector 18,
or on the basis of an arbitrary noise model, notably describing the baseline of the electrical signal.

The inversion of the signal based on the dictionary compiled is suitable for establishing signal components, the proportion value of a species sought being dependent on a plurality of components.

As stated above, knowing the proportion values {C₁, . . . , Cⱼ, . . . , C_{N}} of the gas species of the sample E makes it possible to obtain the heating value of the gas from which the sample is extracted very simply.

As a general rule, in order to define the dictionary during the phase 100 and perform the model inversion during step 108, a principal value analysis, an independent value analysis, or a parsimonious value analysis may be performed.

Principal value analysis provides atoms illustrating the maximum data variance, but involves the drawback of requiring a Gaussian distribution of the data and requiring orthogonality between components.

Independent component analysis does not involve this drawback by not requiring component orthogonality and not requiring that the Gaussian distribution of the data is true.

Parsimonious component analysis provides a largely redundant dictionary wherein the atoms have a parsimony property. Redundancy is conveyed by the large number of atoms in the dictionary and parsimony consists of defining an object (the sample E) with a minimum of elementary causes (atoms). Parsimony thus makes it possible to choose the most relevant atoms, whereas redundancy ensures a faithful description of the possible compositions. This method proves to be useful in cases where independent component analysis does not provide a sufficient number of atoms to describe the data.

These three types of analyses in order to express a signal using dictionary vector kernels are well-known and as such they will not be detailed. They may use signal decomposition algorithms based for example on iterative processes such as Matching Pursuit or Orthogonal Matching Pursuit.

Alternatively and as mentioned above, it may be sought to determine the composition of the gas mixture analyzed, not on the basis of at least N′ gas species of a dictionary, but on the basis of P′ gaseous substances from a dictionary, each consisting of at least a portion of the N′ gas species, the relative proportions of each of said gas species in each of said gaseous substances being known or predetermined. The adaptation of the dictionary is performed in the same way as the adaptation of the projection basis detailed above.

It is obvious that a method such as that described above, used by the device 10, is suitable, by means of fine probabilistic modeling of the processing chain 12, for providing a reliable estimation of the gas composition of a sample E. In particular, this method excels in individually evaluating the proportions of gas species of the sample, for which conventional analytical methods are less satisfactory.

It should further be noted that the invention is not limited to the embodiments described above. It will indeed be clear to those skilled in the art that various modifications may be made to the embodiments described above, in the light of the teaching described herein.

As such for example, the direct probabilistic model defined above to represent the electrical signal gₖ(t) may be refined or on the other hand simplified.

In particular, in an application wherein the specific composition {C₁, . . . , Cⱼ, . . . , C_{N}} of a gas is not sought, but where merely the gas species considered to be hazardous need to be identified, the detection problem may be reformulated as a problem for estimating a binary variable δ defining the presence (δ=1) or the absence (δ=0) of molecules of a gas species. Such a binary variable δ may then be integrated in the direct probabilistic model and simplify same.

It is also possible to approximate the expression f_{heaviside}(t) e^{-k}^{_{d,j}}^{^{NEMS}}^{t} with a Dirac distribution in the model described above. For this, it is necessary for the characteristic width of the exponential component

$$( \frac{1}{{k}_{d , j}^{NEMS}} )$$

to be sufficiently small relative to the characteristic width of the peak of the law of probability Pⱼ(t, θⱼ), i.e. the second moment of this law.

Also alternatively, some complexity factors may be taken into account in the direct probabilistic model, such as the heterogeneity of the adsorption sites or diffusion problems in the chromatography column, the fact that the injection of the sample E is not ideal (i.e. non-negligent non-null volume), the existence of dead volumes, etc.

In the claims hereinafter, the terms used should not be interpreted as limiting the claims to the embodiments disclosed in the present description, but should be interpreted to include therein any equivalents intended to be covered by the claims due to the wording thereof and which can be envisaged by those skilled in the art by applying general knowledge to the implementation of the teaching disclosed herein.

1. A method for determining a composition of a gas sample processed by means of gas chromatography, comprising the following steps:
running the sample through a processing chain comprising a gas chromatography column and a gas detector arranged at the outlet of the gas chromatography column,
obtaining, at the output of the gas detector, a representative electrical signal of the composition of the sample,
determining the composition of the sample using a device for processing this electrical signal,
wherein the determination of the composition of the sample is performed on the basis of a combination stored in memory:
of a direct probabilistic model of the gas chromatography column, this model comprising at least one law of probability defining, for at least one gas species liable to be found in the sample, a probability at each moment that a molecule of this gas species is discharged from the chromatography column, and
an impulse response model of the gas detector,
and wherein the determination step is performed by inverting this combination of models using the electrical signal, the inversion being performed by the processing device having means for accessing the memory.

2. The method for determining a composition of a gas sample as claimed in claim 1, wherein the direct probabilistic model of the gas chromatography column includes a law of probability defined for each gas species of a reference set of predetermined gas species, this law of probability defining a probability at each moment that a molecule of the gas species in question is discharged from the chromatography column and the parameters of this law being expressed on the basis of technical parameters of the chromatography column including:
an adsorption factor of the gas species in question in the chromatography column,
a desorption factor of the gas species in question in the chromatography column,
a down-time corresponding to the time taken by a carrier gas without affinity with the wall thereof to pass through this chromatography column.

3. The method for determining a composition of a gas sample as claimed in claim 2, wherein the law of probability defined for each gas species in the direct probabilistic model of the gas chromatography column takes the following form:
$${P}_{j} ( t , {θ}_{j} ) = \frac{\sqrt{4 \cdot {k}_{a , j} \cdot {k}_{d , j} \cdot {t}_{0} \cdot t}}{2 \cdot t} \cdot {I}_{1} \cdot ( \sqrt{4 \cdot {k}_{a , j} \cdot {k}_{d , j} \cdot {t}_{0} \cdot t} ) \cdot {e}^{- {k}_{a , j} \cdot {t}_{0} - {k}_{d , j} \cdot t} ,$$
where t is the time, t≧0, the index j identifies the gas species in question, k_{a,j} is the adsorption factor of this gas species in the chromatography column, k_{d,j} is the desorption factor of this gas species in the chromatography column, θⱼ=(k_{a,j}, k_{d,j}), I₁ is the first-order modified Bessel function of the first kind and t₀ is the down-time of the chromatography column.

4. The method for determining a composition of a gas sample as claimed in claim 1, wherein the impulse response model of the gas detector comprises a law of probability defined for each gas species of a reference set of predetermined gas species, this law of probability defining a probabilistic impulse response of the electromechanical gas detector to an impulse constituted by a molecule of the gas species in question.

5. The method for determining a composition of a gas sample as claimed in claim 4, wherein the gas detector is an electromechanical gas detector and the parameters of each law of probability of said impulse response model are expressed on the basis of technical parameters of the electromechanical gas detector including:
an adsorption factor of the gas species in question in the electromechanical gas detector,
a desorption factor of the gas species in question in the electromechanical gas detector,
an interaction time corresponding to the presence time of a molecule in the mobile phase with regard to the electromechanical gas detector.

6. The method for determining a composition of a gas sample as claimed in claim 5, wherein the law of probability defined for each gas species in the impulse response model of the electromechanical gas detector takes the following form:
rⱼ(t)=mmⱼ·(1−e^{-k}^{_{a,j}}^{^{NEMS}}^{·T}^{ₑ})·f_{heaviside}(t)·e^{-k}^{_{d,j}}^{^{NEMS}}^{·t},
where t is the time, the index j identifies the gas species in question, mmⱼ is the molecular mass of this gas species, k_{a,j}^{NEMS} is the adsorption factor of this gas species in the electromechanical gas detector, k_{d,j}^{NEMS} is the desorption factor of this gas species in the electromechanical gas detector, f_{heaviside} is the Heaviside function and Tₑ is the integration time of the electromechanical gas detector.

7. The method for determining a composition of a gas sample as claimed in claim 2, wherein the gas detector is an electromechanical gas detector and the parameters of each law of probability of said impulse response model are expressed on the basis of technical parameters of the electromechanical gas detector including:
an adsorption factor of the gas species in question in the electromechanical gas detector,
a desorption factor of the gas species in question in the electromechanical gas detector,
an interaction time corresponding to the presence time of a molecule in the mobile phase with regard to the electromechanical gas detector,
and wherein the combination of the models stored in memory is a linear combination of convolution products between the laws of probability of the direct probabilistic model of the gas chromatography column and the laws of probability of the impulse response model of the electromechanical gas detector, this linear combination taking the following form:
$${ℊ}_{k} ( t ) = {ℊ}_{0 , k} - {α}_{k} {\sum }_{j = 1}^{N} {C}_{j} \cdot {P}_{j} ( t , {θ}_{j} ) * {r}_{j} ( t ) + ɛ ( t ) ,$$
where t is the time, the index k identifies a fundamental or harmonic resonance frequency mode of the electromechanical gas detector, gₖ (t) is an instantaneous mode k resonance frequency of the electromechanical gas detector, this instantaneous frequency forming the electrical signal obtained at the output thereof, g_{0,k} is an off-load instantaneous mode k resonance frequency of the electromechanical gas detector, αₖ is a mode k weighting constant, N is the number of gas species in the sample, the index j identifies a gas species, Cⱼ is the molecular concentration of this gas species in the sample, Pⱼ(t, θⱼ) is the law of probability of the direct probabilistic model of the gas chromatography column for this gas species, rⱼ(t) is the law of probability of the impulse response model of the gas detector for this gas species and ε(t) is a probabilistic noise model.

8. The method for determining a composition of a gas sample as claimed in claim 1, wherein the inversion of said combination of models includes the following steps:
compiling a basis of N representative vectors of N known gas species of the sample, each vector of this basis being defined in the form Pⱼ(t, θⱼ)*rⱼ(t) where Pⱼ(t, θⱼ) is the law of probability of the direct probabilistic model of the gas chromatography column for the j-th gas species and rⱼ(t) is the impulse response model of the gas detector for the j-th gas species,
inverting said combination of models on the basis of the electrical signal so as to obtain a proportion value for each gas species of the sample.

9. The method for determining a composition of a gas sample as claimed in claim 1, wherein the inversion of said combination of models includes the following steps:
compiling a basis of N representative vectors of N known gas species of the sample, each vector of this basis being defined in the form Pⱼ(t, θⱼ)*rⱼ(t) where Pⱼ(t, θⱼ) is the law of probability of the direct probabilistic model of the gas chromatography column for the j-th gas species and rⱼ(t) is the impulse response model of the gas detector for the j-th gas species,
compiling a dictionary of N′ representative vector kernels, where N′≧N, each gas species being associated with one or a plurality of vector kernels, each vector kernel being obtained:
either on the basis of the vectors (Pⱼ(t, θⱼ)*rⱼ(t))_{1≦j≦N} by modulating the value of some technical parameters, for example chosen from k_{a,j}, k_{d,j}, k_{a,j}^{NEMS}, k_{d,j}^{NEMS}, t₀, Tₑ,
or on the basis of an arbitrary noise model, notably describing a baseline of the electrical signal,
inverting said combination of models on the basis of the electrical signal so as to obtain a proportion value for each gas species of the sample.

10. The method for determining a composition of a gas sample as claimed in claim 1, wherein the Inversion of said combination of models includes the following steps:
compiling a basis of P representative vectors of P known or predetermined gaseous substances of the sample, each vector of this basis being defined in the form Eᵢ(t)=Σⱼ₌₁^{N}p_{i,j}·Pⱼ(t, θⱼ)*rⱼ(t) where Pⱼ(t, θⱼ) is the law of probability of the direct probabilistic model of the gas chromatography column for the j-th gas species, rⱼ(t) is the impulse response model of the gas detector for the j-th gas species and p_{i,j} expresses the probability that a molecule of the i-th gaseous substance is of the j-th gas species,
inverting said combination of models on the basis of the electrical signal so as to obtain a proportion value for each gaseous substance of the sample

11. The method for determining a composition of a gas sample as claimed in claim 1, wherein the inversion of said combination of models includes the following steps:
compiling a basis of P representative vectors of P known or predetermined gaseous substances of the sample, each vector of this base being defined in the form Eᵢ(t)=Σⱼ₌₁^{N} p_{i,j}·Pⱼ(t, θⱼ)*rⱼ(t) where Pⱼ(t, θⱼ) is the law of probability of the direct probabilistic model of the gas chromatography column for the j-th gas species, rⱼ(t) is the impulse response model of the gas detector for the j-th gas species and p_{i,j} expresses the probability that a molecule of the i-th gaseous substance is of the j-th gas species,
compiling a dictionary of P′ representative vector kernels, where P′≧P, each gaseous substance being associated with one or a plurality of vector kernels, each vector kernel being obtained:
either on the basis of the vectors (Eᵢ(t))_{1≦i≦P} by modulating the value of some technical parameters, for example chosen from k_{a,j}, k_{d,j}, k_{a,j}^{NEMS}, k_{d,j}^{NEMS}, t₀, Tₑ,
or on the basis of an arbitrary noise model, notably describing a baseline of the electrical signal,
inverting said combination of models on the basis of the electrical signal so as to obtain a proportion value for each gaseous substance of the sample.

12. The method for determining a composition of a gas sample as claimed in claim 1, wherein the determination step by means of inversion uses a Bayesian estimator.

13. The method for determining a composition of a gas sample as claimed in claim 1, wherein the electrical signal obtained at the output of the gas detector is previously denoised before performing the determination step, this denoising including the removal of a baseline and being carried out by breaking the electrical signal into wavelets and selecting merely a portion of the wavelet components obtained.

14. A device for determining a composition of a gas sample processed by means of gas chromatography, including:
a chain for processing the sample comprising a gas chromatography column and a gas detector arranged at the outlet of the gas chromatography column, designed to supply a representative signal of the composition of the sample, and
a signal processing device designed materially or programmed to apply, in conjunction with the processing chain, a method for determining the composition of the gas sample as claimed in claim 1.

15. The device for determining a composition in terms of gas species of a sample as claimed in claim 14, wherein the gas detector is a NEMS electromechanical detector.
